(19) United States
(12) Patent Application Publication
(10) Pub. No.: US 2006/0209248 A1
(43) Pub. Date: Sep. 21, 2006

(54) Electro-optic device and method of manufacturing the same

(75) Inventor: Hiroyuki Shimada, Kofu-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/333,266

(22) Filed: Jan. 18, 2006

(30) Foreign Application Priority Data
Mar. 15, 2005 (JP) 2005-072712

(51) Int. Cl. G02F 1/1333

(52) U.S. Cl. 349/158

(57) ABSTRACT

An electro-optic device, including an element substrate provided with a semiconductor element, and a light transmissive substrate disposed so as to face the element substrate, wherein the element substrate includes a metal substrate provided with the semiconductor.

### BACKGROUND OF THE INVENTION

1. Technical Field

The present invention relates to an electro-optic device and a method of manufacturing the electro-optic device.

2. Related Art

Recent years, a large number of liquid crystal devices (electro-optic devices) are used for projection equipment, projection televisions or the like. As such a liquid crystal device, a transmissive liquid crystal device for displaying images by transmitting light from the back face (back light) and a reflective liquid crystal device for displaying images by reflecting light once introduced from the outside are cited.

Incidentally, as the reflective liquid crystal device, LCOS (Liquid Crystal On Silicon) is well known, which is composed of a silicon substrate provided with silicon transistors (semiconductor elements) formed thereon for ease of manufacture and a light transmissive substrate for transmitting light from the outside facing each other and then bonded with each other so as to seal the liquid crystal layer between the silicon substrate and the light transmissive substrate. However, when, for example, a high intensity light beam for displaying a sharp image is introduced, the silicon substrate, which absorbs light but has a poor heat discharge property, is heated to a very high temperature. And in that case, the transistors formed on the silicon substrate cannot normally be driven, or the light is doubly reflected in the boundary face of the light transmissive substrate in consequence of the thermal stress, thus degrading the image display quality. Further, the difference in the thermal expansion coefficient between the silicon substrate having high thermal expansion coefficient and the light transmissive substrate having relatively low thermal expansion coefficient compared to the silicon substrate may vary the cell gap of the liquid crystal layer, which degrades the image quality.

Therefore, a technology for enhancing the heat discharge property by attaching the reflective liquid crystal device to a member having a high heat discharge property via an adhesive is known. Such a technology is disclosed in, for example, JP-A-2004-4397.

However, the reflective liquid crystal device (electro-optic device) itself is composed of the silicon substrate (element substrate) having a low heat discharge property as before, and further, it is attached to the high heat discharge property member via the adhesive, therefore, it has been difficult to sufficiently enhance the heat discharge property. And, the difference in the thermal expansion coefficient between the substrates described above still remains, which may cause degradation of the image quality.

### SUMMARY

In view of the technical problems described above, the invention has an advantage of providing an electro-optic device having an enhanced heat discharge property for enabling the semiconductor elements to operate properly, and method of manufacturing the electro-optic device.

In an electro-optic device according to an aspect of the invention includes an element substrate provided with a semiconductor element, and

a light transmissive substrate disposed so as to face the element substrate,

wherein the element substrate includes a metal substrate provided with the semiconductor.

If the electro-optic device according to this aspect of the invention is applied to, for example, a reflective liquid crystal device, by providing light reflecting section to the side of the element substrate, the light from the outside enters the element substrate via the light transmissive substrate, and is reflected by the element substrate. And then, the heat is generated by the light on the side of the element substrate reflecting the light. In this case, the element substrate formed of a metal substrate having a good heat discharging property becomes to efficiently discharge outside the substrate the heat generated by the light form the outside compared to those formed of a silicon substrate having a poor heat discharge property as the reflective liquid crystal device used in the past.

Therefore, by preventing the element substrate of the electro-optic device from having a high temperature, the semiconductor provided on the element substrate can operate properly at any time.

Therefore, since the semiconductor operates properly, a highly reliable electro-optic device can be provided.

In the electro-optic device, the element substrate is preferably provided with a radiating section shaped like fins on a surface opposite to the side of the light transmissive substrate.

By thus configured, a large sized contact area of the element substrate with the outside (air) can be obtained with the radiating section shaped like fins. Therefore, the heat discharging property of the element substrate can further be enhanced.

In the electro-optic device, the metal substrate is preferably made of a material having a thermal expansion coefficient substantially the same as a thermal expansion coefficient of the light transmissive substrate.

By thus configured, since the thermal expansion coefficients of the element substrate formed of the metal substrate and the light transmissive substrate become substantially the same, the heat stress caused by the difference in the thermal expansion coefficient can be prevented. Therefore, if the electro-optic device is the reflective liquid crystal device described above and the liquid crystal layer is provided between the substrates, variation of the cell gap in the liquid crystal layer can be prevented, thus enabling to display favorable images.

In the electro-optic device, the light transmissive substrate is preferably made of glass.

By thus configured, the light transmissive substrate using glass can be made highly transparent and highly light permeable, and further, the thermal expansion coefficient of the light transmissive substrate can also be lowered. Further, by using, for example, an invar alloy having a small thermal expansion coefficient described below, the thermal expansion coefficients of the light transmissive substrate and the element substrate can be set substantially the same.

In the electro-optic device, the metal substrate is preferably made of an invar alloy.

In this case, by using the invar alloy having a small thermal expansion coefficient in general to form the element substrate, a metal substrate having substantially the same thermal expansion coefficient as that of the light transmissive substrate (glass) can be formed by, for example, changing the kind of the invar alloys. Therefore, if the electro-optic device is, for example, the reflective liquid crystal device described above, since there is no difference in the thermal expansion coefficient between the substrates, the heat stress never occurs. Therefore, the electro-optic device can prevent variation in the cell gaps of the liquid crystal layer provided between the substrates thereby displaying preferable images.

A method of manufacturing an electro-optic device according to another aspect of the invention includes the step of transferring a semiconductor element, previously formed on a first substrate and separated from the first substrate, to a metal substrate to form an element substrate, and the step of bonding a light transmissive substrate with the element substrate so as to face the element substrate.

According to the method of manufacturing an electro-optic device of another aspect of the invention, by transferring the semiconductor element to the metal substrate, the semiconductor element is formed on the metal substrate without forming a silicon layer on the metal substrate. Therefore, since the silicon layer is not formed directly on the metal substrate, contamination between the metal substrate and the silicon layer caused by, for example, the heat generated in semiconductor forming process can be prevented.

Further, if the electro-optic device thus formed is applied to the reflective liquid crystal device described above, since the element substrate is composed of the metal substrate having a good heat discharging property, it becomes that the heat generated by the light from the outside can efficiently be discharged outside the substrate.

Therefore, since the semiconductor element provided on the element substrate operates properly at any time, a highly reliable electro-optic device can be manufactured.

A method of manufacturing an electro-optic device according to still another aspect of the invention includes the step of forming a semiconductor element on a metal substrate to form an element substrate using a manufacturing process for low-temperature polysilicon, and the step of bonding a light transmissive substrate with the element substrate so as to face the element substrate.

According to the method of manufacturing an electro-optic device of this aspect of the invention, by forming the semiconductor element with low-temperature polysilicon, contamination from the metal substrate to the silicon layer caused by going through a high-temperature process can be prevented. Therefore, the semiconductor element can preferably be formed on the metal substrate.

Further, as described above, since the semiconductor element operates properly at any time owing to the element substrate having a good heat discharging property, a highly reliable electro-optic device can be manufactured.

### BRIEF DESCRIPTION OF THE DRAWINGS

The invention will now be described with reference to the accompanying drawings, wherein like numbers refer to like elements.

FIG. 1 is a side cross-sectional view schematically showing a reflective liquid crystal device.

FIGS. 2A through 2D are views for explaining a process of forming an element substrate by transferring TFTs.

### DESCRIPTION OF THE EMBODIMENTS

Hereinafter, an embodiment of an electro-optic device and a method of forming the electro-optic device according to the invention will be explained. Note that the electro-optic device denotes a device in general equipped with an electro-optic element capable of emitting light with an electrical operation or of changing the state of the light from the outside, and includes both of those themselves emitting light and those controlling transmission of the light from the outside. For example, an active matrix type of display device equipped with a liquid crystal device, an electrophoretic element having a dispersion medium dispersing electrophoretic particles, an EL (electroluminescence) element, or an electron emission element for emitting light by making the electrons generated by applying the electric field hit against the light emitting plate as the electro-optic element, and so on is cited. Further, the scale size of each member is accordingly altered so that the member is shown large enough to be recognized in the drawings used in the following descriptions.

In the present embodiment, the case in which a reflective type of liquid crystal device (hereinafter referred to as a reflective liquid crystal device) is used as the electro-optic device is described.

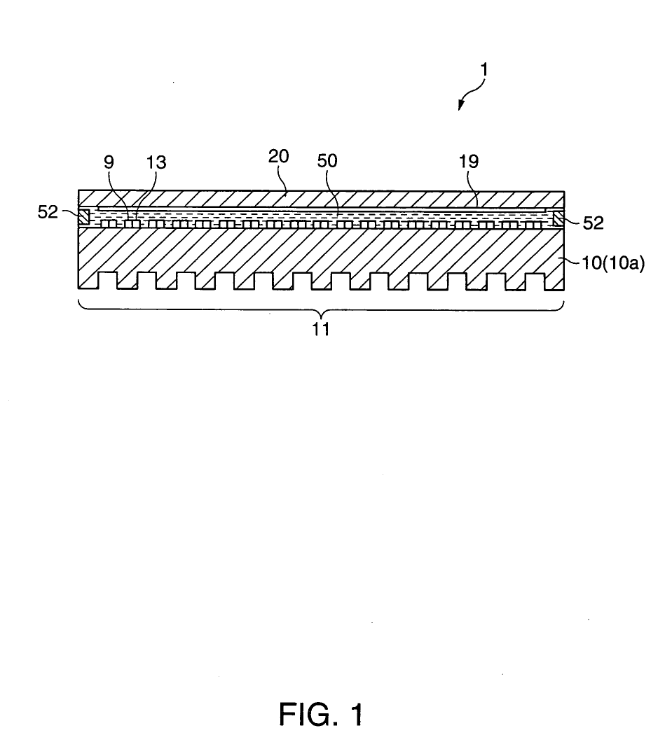

FIG. 1 is a view for showing a side cross-section of the reflective liquid crystal device of the present embodiment. In FIG. 1, the reference numeral 1 denotes the reflective liquid crystal device.

As shown in FIG. 1, the reflective liquid crystal device 1 of the present embodiment is equipped with an element substrate 10 having TFTs (semiconductor elements) and a light transmissive substrate 20 disposed so as to face the element substrate 10, and has a configuration in which the element substrate 10 and the light transmissive substrate 20 are bonded with each other via a seal member 52 so as to face each other and a liquid crystal layer 50 is sealed in a region surrounded by the seal member 52. And, the surfaces of the element substrate 10 and the light transmissive substrate 20 contiguous with the liquid crystal layer 50 are each provided with an oriented film not shown in the drawings.

Note that, although in the reflective liquid crystal device 1, a wave plate, a deflecting plate, and so on are disposed in appropriate orientations in accordance with a nature of the liquid crystal in use, namely, the operational mode such as a TN (Twisted Nematic) mode, a STN (Super Twisted Nematic) mode or a vertical orientation mode, or other modes such as normally white mode or normally black mode, the illustration thereof will be omitted here.

The light transmissive substrate 20 is made of a light permeable material, and formed of a glass (quartz) substrate, for example. As described above, by using glass for the light transmissive substrate 20, the light transmissive substrate 20 can be made highly transparent and highly light permeable, and further, the thermal expansion coefficient of the light transmissive substrate 20 can also be lowered.

On the surface of the light transmissive substrate 20 facing the element substrate 10, there is provided a transparent electrode 19 formed of, for example, ITO. Therefore, as described below, it is arranged that the light emitted from the outside toward the light transmissive substrate 20 is transmitted by the light transmissive substrate 20 and the transparent electrode 19, and is reflected by the side of the element substrate 10.

The element substrate 10 has a structure in which TFTs 13 are provided on a metal substrate 10a with a transfer process described below. And, the TFTs 13 are each provided with a pixel electrode 9 electrically connected thereto. Note that, although wiring and insulating films described below are provided between the TFTs 13 and the pixel electrodes 9, they are not illustrated in FIG. 1 only for the sake of simplification.

And, as a material of the metal substrate 10a, an invar alloy is used.

The invar alloy is an alloy having a remarkably low thermal expansion coefficient as its feature. Taking an alloy of 64% Fe-36% Ni as an example, the thermal expansion coefficient is about a tenth of that of SUS304. Further, the invar alloy has features of having a stable austenite structure, soft and presenting little work hardening, and accordingly having excellent workability.

By appropriately changing the kind of the invar alloys described above, the metal substrate 10a with a desired thermal expansion coefficient can be obtained.

In the present embodiment, as the invar alloy forming the metal substrate 10a, a material capable of obtaining the thermal expansion coefficient substantially the same as that (0.5×10⁻⁶/K) of glass forming the light transmissive substrate 20, for example, Super Invar (a product of Mitsubishi Material Corporation) composed of Ni: Co: Fe=32%: 5%: 63% is used. Super Invar is an alloy presenting the lowest thermal expansion coefficient of all metallic materials. It resents the thermal expansion coefficient as low as less than 1.0×10⁻⁶/K, which can be substantially the same as the thermal expansion coefficient of glass mentioned above.

Therefore, the reflective liquid crystal device 1 is arranged to prevent the thermal stress from generating caused be the difference in the thermal expansion coefficient by setting the thermal expansion coefficients of the element substrate 10 and the light transmissive substrate 20 substantially the same.

Note that the element substrate 10 is provided with the pixel electrodes 9 each corresponding to a respective one of pixel areas of the reflective liquid crystal device 1. An image area is provided with a plurality of scan lines, a plurality of data lines extend in a direction traversing the scan lines, a capacitance line extends in parallel to each of the plurality of scan lines, and is composed of areas surrounded by the scan lines and the data lines.

In each of the pixel areas, there are formed the pixel electrode 9 and the TFT 13 as a pixel switching element electrically connected to the pixel electrode 9. Further, the element substrate 10 is provided with a reflecting section not shown in the drawings for reflecting the light from the outside when functioning as the reflective liquid crystal device 1. In this case, it can be arranged that the pixel electrode 9 it self is utilized as a reflective pixel section by forming the pixel electrode 9 with, for example, Al. Further, a reflecting plate or the like can be separately formed on the side of the element substrate 10 as a reflection section.

The element substrate 10 is provided with a radiating section 11 shaped like fins on the opposite surface to the side of the light transmissive substrate 20. The radiating section 11 is made of the same invar alloy as used for the element substrate 10, and functions for enhancing the heat discharge property in the element substrate 10 as described below. In this case, the radiating section 11 can be connected to the element substrate via brazing filler metal, or can be formed integrally with the element substrate 10.

By providing the radiating section 11 to the element substrate 10, it is arranged that the contact area of the element substrate 10 with the outside (air) can be enlarged, thus enhancing the heat discharging property of the reflective liquid crystal device 1.

Hereinafter, the case in which an image is displayed on a screen applying the reflective liquid crystal device 1 to a projection device will be explained.

The reflective liquid crystal device 1 inputs an image signal supplied from the data line to the pixel electrode 9 at a predetermined timing by switching the TFT 13 by a scan signal supplied form the scan line provided on the element substrate 10. And, the image signal is held between the pixel electrode 9 and the transparent electrode 19 facing across the liquid crystal layer 50 so as to hold the liquid crystal layer 50 therebetween.

As described above, the reflective liquid crystal device 1 reflects the light from the outside entering from the side of the light transmissive substrate 20 by the reflecting section (not shown) provided on the side of the element substrate 10, and at the same time modulates the light in accordance with the image signal held as described above to project it on the screen as the display light (image).

Incidentally, the element substrate 10, which reflects the light entering to the element substrate 10 through the light transmissive substrate 20, is heated by the light to have the heat. In this case, the reflective liquid crystal device 1, which has the element substrate 10 formed of a metal substrate having a good heat discharging property, becomes to efficiently discharge the heat generated by the light form the outside to the outside of the substrate compared to those formed of a silicon substrate having a poor heat discharge property as the reflective liquid crystal device used in the past. Further, the element substrate 10 in the present embodiment, which is equipped with the radiating section 11 to enlarge the contact area with the outside (air), can more efficiently discharge the heat.

Therefore, the element substrate 10 can be prevented form having a high temperature in consequence of the light from the outside, thus the TFTs 13 provided on the element substrate 10 can always operate properly.

Further, the element substrate 10 formed of the invar alloy and the light transmissive substrate 20 formed of glass have substantially the same thermal expansion coefficients, thus preventing the thermal stress caused by the difference between the thermal expansion coefficients. Therefore, the reflective liquid crystal device 1, in which the cell gap (distance) of the liquid crystal layer 50 is not varied by the thermal stress, can display favorable images.

Accordingly, the reflective liquid crystal device 1, which can make the TFTs 13 operate properly, inputs the stable image signals to the pixel electrodes 9, thus enhancing the reliability by preventing unevenness in images and degradation of display quality.

Method of Manufacturing Electro-optic Device

Hereinafter, regarding a method of manufacturing an electro-optic device according to the invention will be explained with reference to the figures showing a manufacturing process of the reflective liquid crystal device 1.

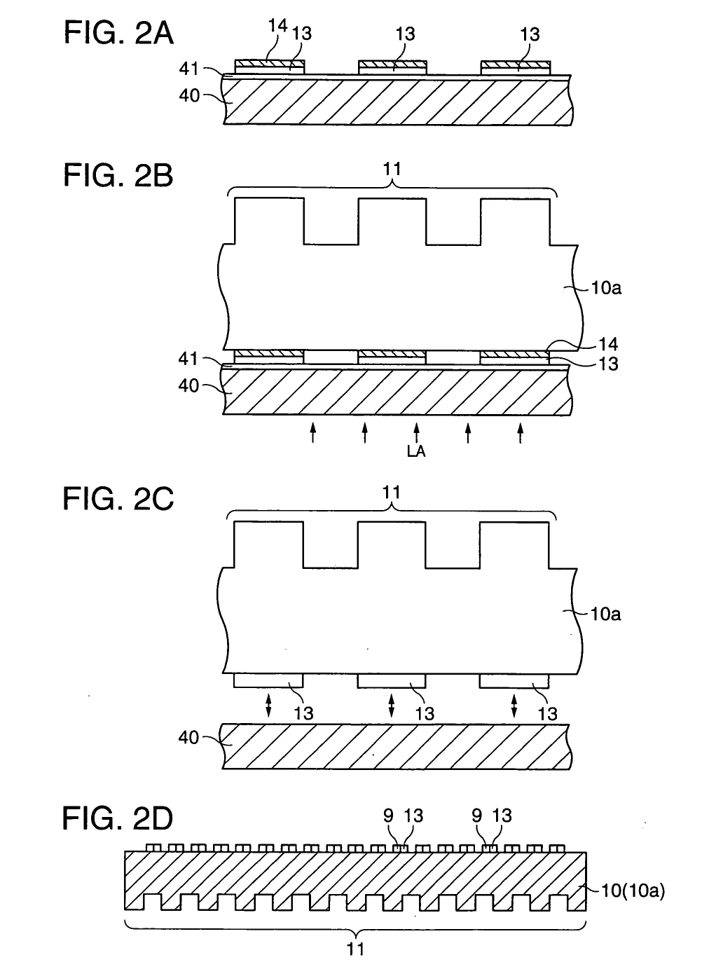

FIGS. 2A through 2D are explanatory views of the process and show a process of manufacturing the reflective liquid crystal device 1.

The method of manufacturing the reflective liquid crystal device 1 includes a step in which, after forming the TFTs (semiconductor elements) 13 on a base substrate (a first substrate), the TFTs 13 are separated from the base substrate and are transferred on the metal substrate 10a to form the element substrate 10, and a step of bonding the light transmissive substrate 20 with the element substrate 10 so as to face the element substrate 10. Note that, although each step of the manufacturing method of the reflective liquid crystal device 1 can be executed in the above order; the order of the steps can be changed if necessary, or the procedures in each step described below can be changed if necessary.

Further, in the present embodiment, SUFTLA (Surface Free Technology by Laser Ablation) (registered trade mark) technology is utilized to transfer the TFTs. Note that other known technologies can be adopted as the technology utilized to transfer the TFTs and so on.

Base Substrate Preparation Step

Firstly, a step of providing the TFTs 13 on the base substrate (the first substrate) 40 will be explained.

In this step, as shown in FIG. 2A, an amorphous Si layer 41 is formed firstly on the base substrate 40, and then, a plurality of TFTs 13 is arranged and then formed on the amorphous Si layer 41. The TFTs 13 are arranged with a predetermined distances therebetween. The TFT 13 is a thin film transistor or the like, and is provided with wiring (not shown) for electrically connected to the pixel electrode 9 and so on after a transfer step described below. As such a wiring, metallic materials having high conductivity such as Al can be used, and for forming the wiring, a vapor deposition process or a sputtering process can be used. Namely, the TFT 13 is defined here to include the thin film transistor and the wiring connected thereto and so on.

Note that, since the specific manufacturing method of the TFTs 13 adopts known technologies including a high-temperature process, the descriptions therefor are omitted, and the base substrate 40 and the amorphous Si layer 41 are described.

The base substrate 40 is a member used only from the present step to a step of bonding the element substrate, but not the component of the reflective liquid crystal device 1. Specifically, a translucent heat-resistant substrate such as a quartz glass, which can stand for 1000° C., can preferably be used, but other than the quartz glasses, heat-resistant glasses such as a soda glass, Corning 7059, or Nippon Electric Glass OA-2 can also be used.

When the amorphous Si layer 41 is irradiated with a laser beam or the like, separation occurs either inside or in the interface of the amorphous Si layer 41. The amorphous Si layer 41 is composed of amorphous silicon (a-Si) including hydrogen (H). Since hydrogen is included, hydrogen (gas) is generated by irradiation of the laser beam to generate inner pressure inside the amorphous Si layer 41, thus promoting the intra-layer separation or the interfacial separation. The content of hydrogen is preferably greater than about 2 at %, and further preferably in a range of 2 at % through 20 at %.

Note that, since the function of the amorphous Si layer 41 is to cause the intra-layer separation or the interfacial separation in response to irradiation of the laser beam or the like, the composition thereof is not limited to the above, but can be a material causing the intra-layer separation or the interfacial separation by creating ablation by the light energy, those causing separation by a gas generated by vaporizing an ingredient with the light energy, or a material causing the intra-layer separation or the interfacial separation by a gas generated by vaporizing the composing material itself.

For example, silicon dioxide, silicate compounds, nitride ceramics such as silicon nitride, aluminum nitride, or titanium nitride, organic polymeric materials (in which the interatomic bond is broken by irradiation with light beams), and metals such as Al, Li, Ti, Mn, In, Sn, Y, La, Ce, Nd, Pr, Gd, or Sm, or alloys including at least one of these metals can be cited.

As a fabrication method of the amorphous Si layer 41, CVD processes, in particular a low-pressure CVD process or a plasma CVD process can be used.

Note that, in case the amorphous Si layer 41 is composed with other materials, any processes capable of forming the amorphous Si layer 41 in an uniform thickness can be selectively used in accordance with various conditions such as the composition or the thickness of the amorphous Si layer 41. For example, various vapor deposition processes such as a CVD (including MOCCVD, low-pressure CVD, ECR-CVD) process, an evaporation process, a molecular beam deposition (MB) process, a sputtering process, an ion doping process, or a PVD process, various plating processes such as an electroplating process, a dipping plating process, or an electroless plating process, coating processes such as a Langmuir-Blodgett (LB) process, a spin coat process, a spray coat process, or a roll coat process, various printing processes, a transfer process, an inkjet process, a powder-jet process, and so on can be used. Further, two or more of these processes can be used in combination. Further, in case the amorphous Si layer 41 is formed with ceramics by a sol-gel process, or with an organic polymeric material, a coating process, in particular a spin coat process is preferably used to form the film.

After forming the TFTs 13 on the amorphous Si layer 41 as described above, adhering layers 14 for adhering with the metal substrate 10a are selectively formed only on the upper surface (the surface with which the TFTs 13 are transferred to the metal substrate 10a) of the TFTs 13 as shown in FIG. 2A.

TFT Transfer Step

Hereinafter, a step of transferring the TFTs 13 formed on the base substrate 40 to a transfer-target member will be explained.

In the embodiment of the invention, the metal substrate 10a having a good heat discharging property is used as the transfer-target member. Namely, by transferring the TFTs 13 to the metal substrate 10a to form the element substrate, the TFT transfer step is completed.

Firstly, the metal substrate 10a as the transfer-target member is provided.

In this case, on the surface of the metal substrate 10a to which the TFTs 13 are transferred, there is formed, for example, an insulating film made of SiO₂ or the like not shown in the drawings. Further, the thickness of the insulating film is arranged to be capable of maintaining an insulating function between the metal substrate 10a and the TFTs 13, and to give no influence to the heat discharging property of the element substrate 10.

As a material of such a metal substrate 10a, invar alloys having a very small thermal expansion coefficient, a stable austenite structure, softness and little work hardening, and excellent workability are used.

In the present embodiment, the invar alloy having a thermal expansion coefficient substantially the same as the thermal expansion coefficient (0.5×10⁻⁶/K) of glass (quartz) forming the light transmissive substrate 20 is used. Specifically, Super Invar (a product of Mitsubishi Material Corporation) mentioned above is used.

And, the metal substrate 10a and the base substrate 40 are bonded with each other. And then, the adhering layers 14 are heated to get into the state in which the metal substrate 10a and the TFTs 13 are adhered via the adhering layers 14.

After then, as shown in FIG. 2B, a laser beam LA is irradiated from the back surface (the surface on which no TFT is formed) of the base substrate 40 locally to the amorphous Si layer 41 contiguous with the TFTs 13. In this case, the laser irradiation is preferably executed under the temperature condition of no higher than 550° C. Accordingly, the bonding forces between atoms or molecules in the amorphous Si layer 41 are weakened, and hydrogen in the amorphous Si layer 41 forms molecules to be separated from the crystal bond, namely the bonding forces between the TFTs 13 and the base substrate 40 completely disappear to enable the TFTs 13 located in the portions irradiated with the laser beam LA to be easily detached therefrom.

As described above, the element substrate 10 can be composed of the metal substrate 10a having a good heat discharging property, thereby efficiently discharging to the outside the heat generated in the element substrate 10 by the light from the outside. Further, one of the surfaces of the metal substrate 10a, which is an opposite surface to the surface to be bonded with the light transmissive substrate 20, is provided with the radiating section 11 shaped like fins.

By providing the radiating section 11 to the element substrate 10, it is arranged that the contact area of the element substrate 10 with the outside (air) can be enlarged, thus enhancing the heat discharging property of the element substrate 10. Note that the radiating section 11 can be provided via the brazing filler metal such as indium on the element substrate 10 after the element substrate 10 has been formed by transferring the TFTs 13 on the metal substrate 10a.

Further, as described above, since the metal substrate 10a made of the invar alloy is used, the thermal expansion coefficients of the element substrate 10 and the light transmissive substrate 20 forming the reflective liquid crystal device 1 can be set to be substantially the same, thus preventing generation of the thermal stress caused by the difference in the thermal expansion coefficient. Therefore, the reflective liquid crystal device 1 can prevent variation in the cell gap (distance) of the liquid crystal layer 50 provided between the substrates 10 and 20 described above.

Subsequently, as shown in FIG. 2C, the TFTs 13 are removed from the base substrate 40 and simultaneously get into the condition of being transferred to the metal substrate 10a by peeling the base substrate 40 and the metal substrate 10a from each other.

As described above, since the TFTs 13 are transferred on the metal substrate 10a using the SUFTLA process in the manufacturing method of the electro-optic device according to the present embodiment, the TFTs 13 can be formed on the metal substrate 10a without providing a silicon layer on the metal substrate 10a. Therefore, since the silicon layer is not formed on the metal substrate 10a, the element substrate 10 can be formed while preventing any contamination between the metal substrate 10a and the silicon layer.

Subsequently, the element substrate 10 is reversed to form, for example, an insulating film not shown made of SiO₂ or the like as is the case with the method used in the past. And then, the insulating film is provided with contact holes and so on, and further the pixel electrodes 9 are formed so as to be connected to the respective TFTs 13 via the contact holes.

In this case, by forming the pixel electrodes 9 with, for example, Al or the like, the pixel electrodes 9 themselves can be utilized as the reflecting plates for reflecting the light from the outside. Further, the reflecting plate can be separately provided on the pixel electrode 9, or if the pixel electrode 9 is made of a transparent material such as ITO or the like, the reflecting plate can be provided under the pixel electrode 9. By thus configured, the element substrate 10 becomes to reflect the light from the outside.

Note that on the element substrate 10, there are formed the drive circuit section for switching the TFTs 13 such as signal lines or the data lines, and so on.

As described above, as shown in FIG. 2D, the element substrate 10 provided with the TFTs 13 on the metal substrate 10a can be obtained. Note that, although the wiring and the insulating film described above are provided between the TFT 13 and the pixel electrode 9, they are not illustrated in FIG. 2D only for the sake of simplification.

In the embodiment described above, as described above, although the TFTs 13 are formed on the metal substrate 10a by transferring using the SUFTLA technology, the TFTs can also be formed on the metal substrate 10a to form the element substrate 10 using the manufacturing process for low-temperature polysilicon.

In this manufacturing process, for example, an amorphous silicon film is formed on the metal substrate 10a. And then, the amorphous silicon film on the metal substrate 10a is melted by irradiation with the excimer laser (wavelength of 308 nm) at a temperature no higher than 550° C., and then cooled to be recrystallized to form a polysilicon layer. After forming the polysilicon layer, the TFTs can be formed on the metal substrate 10a using a known method. As described above, by using the manufacturing process of the low-temperature polysilicon at a temperature no higher than 550° C., contamination of the metal substrate by the silicon can be prevented. Therefore, since the TFTs properly operate at any time owing to the element substrate 10 equipped with the metal substrate 10a having an excellent heat discharging property in a similar manner to the embodiment described above, a highly reliable reflective liquid crystal device can be manufactured.

As the final step, the element substrate 10 provided with the TFTs 13 on the metal substrate 10a and the light transmissive substrate 20 provided with the transparent electrode 19 formed using a known method are bonded so as to face each other. In this case, the element substrate 10 and the light transmissive substrate 20 are bonded so as to face each other via the seal member 52 as shown in FIG. 1, the liquid crystal layer 50 is sealed in the region surrounded by the seal member 52.

Through the manufacturing process described above, the reflective liquid crystal device 1 is completed.

According to the manufacturing method of the reflective liquid crystal device 1 of the embodiment of the invention, since the TFTs 13 are transferred on the metal substrate 10a, the TFTs 13 can be formed on the metal substrate 10a without providing a silicon layer on the metal substrate 10a. As described above, since the silicon layer is not formed on the metal substrate 10a, contamination between the metal substrate 10a and the silicon layer can be prevented.

Further, since the reflective liquid crystal device 1 thus manufactured has the element substrate 10 formed of the metal substrate 10a with a good heat discharging property, the heat generated by the light from the outside can effectively be discharged outside the substrate thereby maintaining the proper operations of the TFTs provided on the element substrate 10, thus enhancing the reliability by preventing unevenness in images and degradation of display quality.

Note that the invention is not limited to the embodiments described above, but various modifications are possible. For example, although the reflective liquid crystal device is described in the above embodiments, the invention can be applied to DLP (Digital Light Processing, a trade mark of Texas Instrument Incorporated) projecting devices, organic EL display devices, and so on as the electro-optic device.

The entire disclosure of Japanese Patent Application No. 2005-072712, filed Mar. 15, 2005 is expressly incorporated by reference herein.

What is claimed is:

1. An electro-optic device, comprising:
an element substrate provided with a semiconductor element; and
a light transmissive substrate disposed so as to face the element substrate,
wherein the element substrate includes a metal substrate provided with the semiconductor.

2. The electro-optic device according to claim 1, wherein the element substrate is provided with a radiating section shaped like fins on a surface opposite to the side of the light transmissive substrate.

3. The electro-optic device according to claim 1, wherein the metal substrate is made of a material having a thermal expansion coefficient substantially the same as a thermal expansion coefficient of the light transmissive substrate.

4. The electro-optic device according to claim 3, wherein the light transmissive substrate is made of glass.

5. The electro-optic device according to claim 3, wherein the metal substrate is made of an invar alloy.

6. A method of manufacturing an electro-optic device, comprising:
transferring a semiconductor element, previously formed on a first substrate and separated from the first substrate, to a metal substrate to form an element substrate; and
bonding a light transmissive substrate with the element substrate so as to face the element substrate.

7. A method of manufacturing an electro-optic device, comprising:
forming a semiconductor element on a metal substrate to form an element substrate using a manufacturing process for low-temperature polysilicon; and
bonding a light transmissive substrate with the element substrate so as to face the element substrate.
